(19) United States
(12) Patent Application Publication
(10) Pub. No.: US 2002/0065713 A1
(43) Pub. Date: May 30, 2002

(54) Coupon delivery via mobile phone based on location

(76) Inventors: Faisal M. Awada, Round Rock, TX (US); Herman Rodriguez, Austin, TX (US); Newton James Smith JR., Austin, TX (US); Clifford Jay Spinac, Austin, TX (US)

Correspondence Address: Duke W. Yee, Carstens, Yee & Cahoon, LLP, P. O. Box 802334, Dallas, TX, 75380, US

(21) Appl. No.: 09/726,013

(22) Filed: Nov. 29, 2000

(51) Int. Cl. G06F 17/60

(52) U.S. Cl. 705/14

(57) ABSTRACT

A method for delivering coupons to consumers via mobile communication devices, based on location. The present invention includes an electronic database of merchant coupons. Users can then access the database by means of mobile phone, laptop computer, personal digital manager (PDA) or other mobile device. The user receives a menu of service preferences such as retail, dining, automobile service, lodging and entertainment and selects the desired services. Discount coupons for merchants in the user's vicinity are then sent to the user. The coupons are chosen based on the selected preferences and the user's location, which is determined according to the remote transmitting tower through which the user's signal is being sent.

### CROSS REFERENCE TO RELATED APPLICATION

The present application is related to co-pending U.S. patent application Ser. No. 09/240,963 (IBM Docket No. AT9-98-913) filed Jan. 29, 1999. The above mentioned patent application is assigned to the assignee of the present invention. The content of the cross referenced co-pending application is hereby incorporated herein by reference.

### BACKGROUND OF THE INVENTION

1. Technical Field

The present invention relates to mobile communications systems and more specifically to the use of mobile communications systems for accessing goods and services.

2. Description of Related Art

Many merchants offer coupons for services and products. These coupons can take many forms and are redeemed by consumers in order to receive discounts. However, consumers may not always be aware of potential coupons available to them at various locations, especially when the consumers are traveling or are away from home. Whether shopping around town or traveling cross country, consumers do not have a ready means of discovering and taking advantage of coupons offered by local merchants.

Given the near ubiquity of mobile phones, laptop computers and other portable communications devices, consumers should be able to remotely access a data base containing information about coupons for services and products offered at the consumers' current location.

Currently, there is no method for consumers to use mobile communications means to find local merchants offering coupons. Therefore, it would be advantageous if a consumer could find relevant coupons based on his or her location, in proximity to the current mobile communication transmitting station.

### SUMMARY OF THE INVENTION

The present invention provides a method for delivering coupons to consumers via mobile communication devices, based on location. The present invention includes an electronic database of merchant coupons. Users can then access the database by means of mobile phone, laptop computer, personal digital assistant (PDA) or other mobile device. The user receives a menu of service preferences such as retail, dining, automobile service, lodging and entertainment and selects the desired services. Coupons for merchants in the user's vicinity are then sent to the user. The coupons are chosen based on the selected preferences and the user's location, which is determined according to the remote transmitting tower through which the user's signal is being sent.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a schematic diagram illustrating a mobile communication system within which the present invention may be implemented;

FIG. 2 depicts a block diagram of a data processing system which may be implemented as a server in accordance with the present invention;

FIG. 3A depicts a diagram illustrating a mobile phone in accordance with a preferred embodiment of the present invention;

FIG. 3B depicts a block diagram illustrating the hardware configuration of a mobile phone in accordance with a preferred embodiment of the present invention;

FIG. 4 depicts a flowchart illustrating a method for delivering coupons via mobile phone based on location, in accordance with the present invention;

FIG. 5 depicts a flowchart illustrating the method of the present invention from the perspective of a server;

FIG. 6A depicts tables illustrating a relational database used to store and update merchant data in accordance with the present invention;

FIG. 6B depicts a flowchart illustrating a method for retrieving a coupon from the relation database; and

FIG. 7 depicts a flowchart illustrating an example of how a customer may redeem an electronic coupon in accordance with the present invention.

### DETAILED DESCRIPTION OF THE PREFERRED EMBODIMENT

Referring now to FIG. 1, a schematic diagram illustrating a mobile communication system within which the present invention may be implemented is depicted. The architecture depicted in FIG. 1 is that of a simple mobile phone system. However, it must be kept in mind that the present invention can be used with any form of wireless communication system capable of determining the user's location. FIG. 1 is presented merely as an example.

In mobile phone network 100, communication begins when a user activates a mobile phone 102. The phone 102 must first establish contact with a base station, which is a collection of equipment that communicates with other mobile phones. In FIG. 1, transmitting towers 104-112 are base stations within mobile phone network 100. Each base station 104-112 covers a geographical area. A mobile phone system may consist of up to thousands of base stations, covering a large region. Upon activation, phone 102 begins scanning several control channels. Each channel carries signals from one of the base stations 104-112 in the vicinity of phone 102. The specific channel to which phone 102 may tune can be assigned in several ways. As an example, phone 102 may tune to the channel with the strongest signal. However, other methods for the initial assignment of a mobile phone to a particular base station are available and well known within the art. In the example of FIG. 1, phone 102 has tuned in to the control signal from base station 104.

When the user of the phone 102 wants to transmit a signal, the phone 102 sends a service request to base station 104, which includes the phone number the user is trying to reach. Base station 104 then relays the request from phone 102 to a switch 114. This switch 114 is responsible for moving information through the fixed parts of the communications network 100 and is connected to a server 200. Switch 114 is responsible for all of the communications between the base stations 104-112 and can communicate by means of wireless or ground line connections such as, for example, fiber optics or microwave links.

Mobile communications network 100 might rely on Wireless Application Protocol (WAP) for facilitating communications. WAP is a standard for providing wireless phones, pagers and other handheld devices with secure access to e-mail and text-based Web pages. WAP provides a complete environment for wireless applications that includes a wireless counterpart of TCP/IP and a framework for telephony integration such as call control and phone book access. WAP features the Wireless Markup Language (WML), which was derived from Phone.com's HDML and is a streamlined version of HTML for small screen displays. It also uses WMLScript, a compact JavaScript-like language that runs in limited memory. WAP also supports handheld input methods such as a keypad and voice recognition. Independent of the air interface, WAP runs over all the major wireless networks in place. It is also device independent, requiring only a minimum functionality in the unit so that it can be used with a myriad of phones and handheld devices.

Switch 114 takes the request received from phone 102 via base station 104 and establishes a connection with the target designated in the request. The target may be mobile or fixed, and may be within communications network 100 or within another communications network.

If the mobile phone 102 is moving, the switch 114 may receive a report from the original base station 104 indicating that the signal from phone 102 is getting weaker. At this point, the switch 114 sends messages to the other base stations 106-112 asking for reports as to the relative strength of the signal coming from phone 102. If, for example, base 108 reports a strong signal, the switch 114 will initiate a “handoff” from base 104 to base 108, which requires the phone 102 to tune in to the traffic channel of base 108.

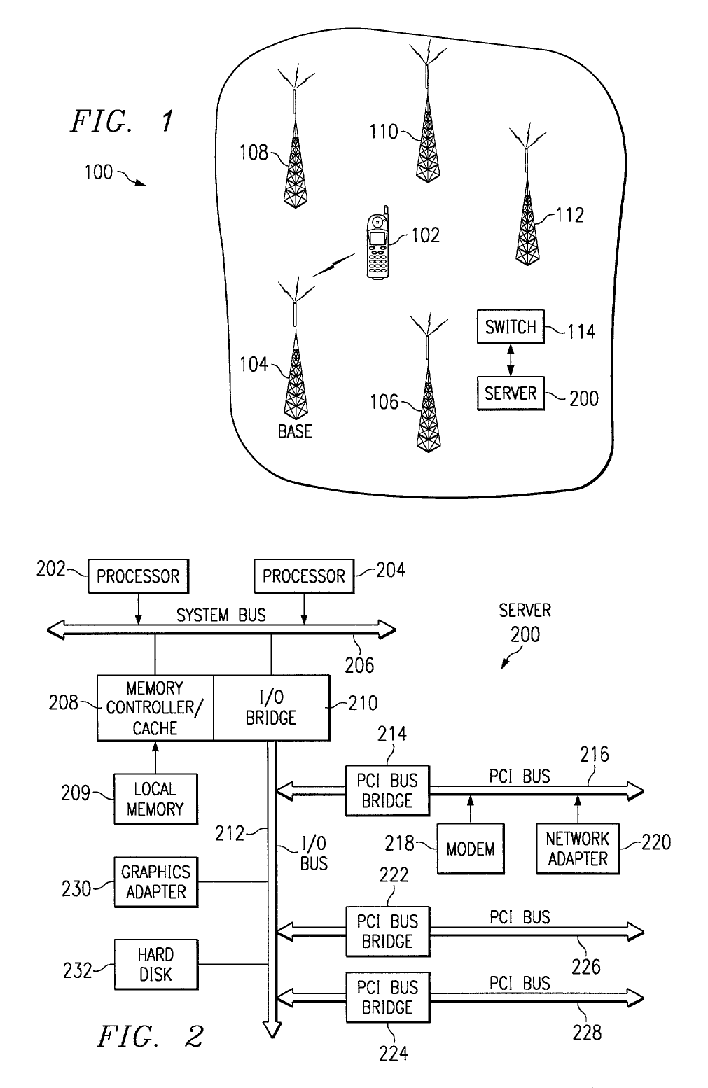

Referring to FIG. 2, a block diagram of a data processing system which may be implemented as a server, such as server 200 in FIG. 1, is depicted in accordance with the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems 218-220 may be connected to PCI bus 216. Typical PCI bus implementations will support four PCI expansion slots or add-in connectors. Communications links to network computers may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A memory mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RS/6000, a product of International Business Machines Corporation in Armonk, New York, running the Advanced Interactive Executive (AIX) operating system.

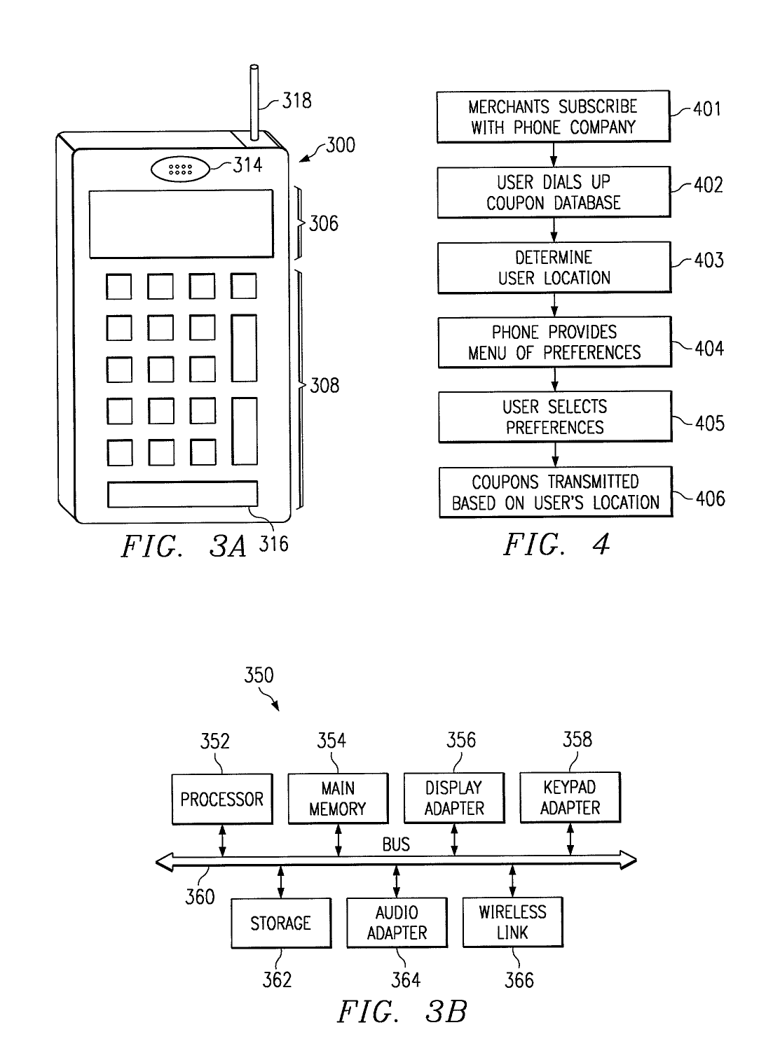

With reference now to FIG. 3A, a diagram illustrating a mobile phone, similar to phone 102 in FIG. 1, is depicted in accordance with a preferred embodiment of the present invention. Mobile phone 300 includes a display 306 for presenting textual and graphical information. Display 306 may be a known display device, such as a liquid crystal display (LCD) device.

Mobile phone 300 may also include keypad 308, speaker 314, and microphone 316. The keypad may be used to enter, for example, telephone numbers, user identification information, and commands for interacting with the interface. Audio feedback may be presented via speaker 314. In addition to normal voice conversation, feedback may include other information, for example, location. And microphone 316 can be used not only for voice conversation, but for entering specific voice commands for voice actuated functions.

Mobile phone 300 also includes antenna 318, which is necessary for establishing wireless communication links with remote transmitting towers, similar to towers 104-112, in FIG. 1.

Turning now to FIG. 3B, a block diagram illustrating the hardware configuration of a mobile phone is shown in accordance with a preferred embodiment of the present invention. Mobile phone 350 is an example of the possible hardware configuration of mobile phone 300 in FIG. 3A and illustrates the increasing sophistication of modern mobile phone designs.

Mobile phone 350 employs bus architecture. Processor 352 and main memory 354 are connected to bus 360. Display adapter 356, keypad adapter 358, storage 362, and audio adapter 364 are also connected to bus 360. Mobile phone 350 also includes wireless link 366 connected to bus 360.

Those of ordinary skill in the art will appreciate that the hardware in FIG. 3B may vary depending on the implementation. Other internal hardware or peripheral devices may be used in addition to or in place of the hardware depicted in FIG. 3B. The depicted example in FIG. 3B and above-described examples are not meant to imply architectural limitations.

Although the depicted representation shows a specialized device, other embodiments of the present invention may be implemented in other types of devices such as pagers, personal digital assistants (PDA), palmtop computers, laptop computers with wireless modems, and any other type of wireless communications device.

Referring to FIG. 4, a flowchart illustrating a method for delivering coupons via mobile phone based on location is depicted in accordance with the present invention. The example in FIG. 4 makes use of the ability to track the location of users of mobile phones, as described in FIG. 1. However, it should be pointed out that the present invention is not limited to use with mobile phones.

The present invention involves a central database of merchants offering coupons, which can be remotely accessed by consumers using a mobile communications device, such as a mobile phone. This database can be stored on a data processing system within the phone company, such as server 200 described above. In the example presented in FIG. 4, merchants who wish to offer coupons to potential customers subscribe with a telephone company (step 401). The phone company will then place the merchants and a list of their coupons within a central database.

Coupons are targeted to unique phone customers based on the user demographic (i.e. male, female, calling plan analysis, calling plan usage, etc.). The phone company maintains these records. For example, if the phone user travels frequently to another city, that caller is a more likely candidate to use visitor services such as hotels, restaurants, etc., than a local customer. The phone company uses that calling plan analysis and offers merchants the ability to target coupons based on that data mining. As another example, the phone company can create a “traveler user profile” database which merchants can use to determine whether or not to target coupon delivery. In that case, the merchant scans the database to determine if any product (and coupon) is adequate for the profile.

It is likely the merchant will pay a fee for any coupon delivered to all users that fit a certain profile. The phone company may provide unrestricted access to all merchants, and only coupons delivered are charged to the merchants. The merchant may also specify that coupons are to be delivered to phone users within a particular geographic area (or group of areas) that fit a certain profile. Once a merchant scans the user profile database, the merchant can create and store electronic coupons in the phone company's coupon database. These coupons would contain features selected by the merchant. For example, the merchant will select which goods or services will be covered by the coupons, how much of a discount to offer, the business hours during which the coupons are valid, and any other features that would normally be found with paper coupons.

If consumers wish to find out about coupons offered in the vicinity of their present location, they can use a mobile phone to dial up the database of merchant coupons (step 402). The server in the phone system determines the location of the user (step 403). This can be accomplished by referencing the base station through which the user's request is being sent, as described in FIG. 1. In addition, the phone system can also triangulate the exact location of the phone itself, which is a method presently being adopted throughout United States for purposes of emergency services, such as 911 calls.

When the database is accessed, the phone provides a menu from which the user can select service preferences (step 404). The menu can be presented as an audio menu, a text menu, or displayed as a graphical user interface (GUI). The service preferences to choose from might include, for example, retailers, restaurants, car services, lodging, and entertainment. A generic preference to receive all coupons for a particular area could also be provided in the menu. The preference menu may also include the intended destination of the user. The user then chooses among the list of preferences in the menu (step 405). Entering the choice of preference can be done either verbally, by means of the keys on the phone, or through a touch screen interface on the phone. This process is an example of a “pull” method, in which the user actively enters specific data and requests coupons from the database.

Instead of selecting preferences every time the database is accessed, the user may store a set of preselected preferences (i.e. electronics and sporting goods) and create his or her own user profile, which the database will automatically filter on. This is an example of a “push” method, in which the system already possesses the required data and can automatically send coupons to the user. These preselected preferences may be stored in the mobile phone or by the phone company. However, if preferences are preselected, the user still has the option of returning to a more general menu and selecting other preferences.

As another example of the push method, whenever a phone user that fits a certain profile enters a prescribed region, the coupon(s) is delivered to the user's phone automatically. The phone might be equipped with a menu option to preset whether to accept or reject coupon delivery. If the user selects accept, for example, all coupons are sent to the phone (duplicate coupons are rejected). Even if the user does not subscribe to text messaging, coupons could be provided for free to the consumer. This is an option for the phone company.

The system transmits coupons to the user, based on the user's location and selected preferences (step 406). The coupons can be selected for merchants within a prescribed radius of the user's location. This radius will vary according to the number of base station regions within a communications network and may even overlap with other base station regions. The prescribed radius can also vary depending on the geographic density of merchants. For example, in Montana, the prescribed radius may be 20 miles, while in Manhattan, the radius may be five blocks. This radius data is stored within the phone system. The phone company provides a set of profiles to which the merchants may subscribe. As an example, a “roaming traveler” profile could be targeted if the phone user is anywhere in a geographical area (e.g. in this city), or a “local user” profile for local users within 5 miles of the base station location. Once a merchant selects the profile, the phone company targets phone users that fit that profile. A user's travel history can also be used to create a customized traveler profile. Coupons could then be broadcast to users who regularly travel into a given area.

If the phone user is moving, the direction of travel is another important factor in determining which coupons to send. For example, it would not be useful to send coupons for the particular region a user is in at the moment of accessing the coupon database if that user is moving out of that region and into another. As mentioned above, the user may be able to select intended destination as a preference for coupon selection. In this way, the system will select the coupons for the region in which the user will actually stop and patron merchants, rather than having to constantly cancel and update coupons as the user travels between regions in which he or she has no intention of stopping.

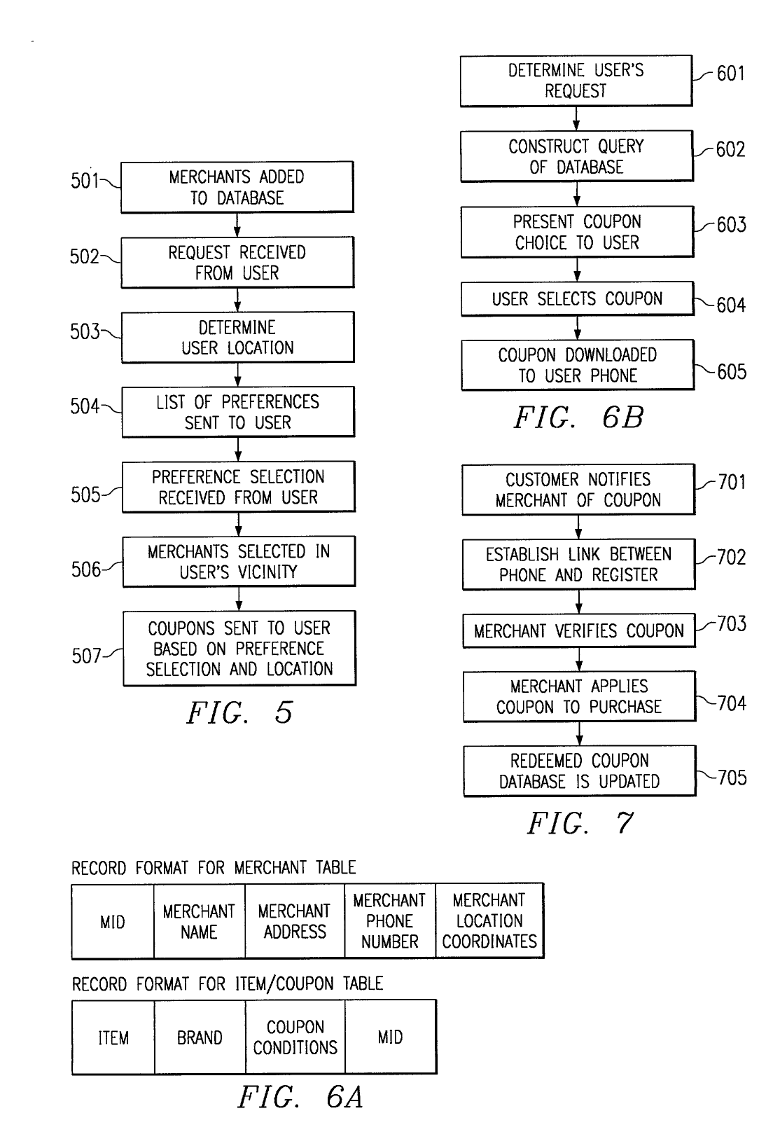

FIG. 5 depicts a flowchart illustrating the method of the present invention from the perspective of a server, such as server data processing system 200 from FIG. 2.

Merchants subscribing with the phone company or internet service provider (ISP) are entered into the database of merchant coupons (step 501). Requests are then received from users by means of a mobile communications device (step 502). As explained in reference to FIG. 4, many devices may be used to access the database server. The server responsible for the coupon database is accessed on a dedicated channel, independent of the other channels used for normal communications, such as voice conversation. This channel may utilize WAP, as described in reference to FIG. 1. The server then determines the location of the user (step 503). As stated in reference to FIG. 4, this can be accomplished by referencing the base station through which the user's request is being sent or triangulating the exact location of the phone itself. The server then transmits a menu of service preferences to the user (step 504). As described above, these preferences relate to the types of goods and/or services the user may wish to purchase. The server then receives the user's selection of preferences (step 505). As noted above, the preferences might be stored in the mobile phone, or by the phone company, in which case the server would automatically receive the preferences when the user signs on in step 502.

The server must then locate merchants within the user's vicinity that provide coupons on the goods and/or services which the user wishes to purchase. Merchants within a predefined radius are selected from the database according to the service preferences of the user (step 506). Coupons redeemable with the selected merchants are then transmitted to the user (step 507). The coupons may be downloaded as WML files, as described in reference to FIG. 1, or some other type of wireless protocol file and can be stored in a coupon folder within the phone, similar to storing phone numbers. The phone can alert the user when a coupon is downloaded or when a coupon is about to expire, similar to alerting the user of an incoming call or voice message.

Referring to FIG. 6A, tables illustrating a relational database used to store and update merchant data are depicted in accordance with the present invention. The first table contains specific information associated with a particular merchant identification (MID). The second table contains information concerning an item (i.e. good or service) and relates that information to a coupon and MID.

The flow used by the database to retrieve coupons is illustrated in FIG. 6B. The database first determines the user request (step 601). This request can be in the form of a preference selection, as explained above, or a specific request for a particular item. The database then constructs a query (step 602) to search the item/coupon table to determine the MIDs of merchants who offer coupons for the designated item(s) and which of those merchants are within the specified radius of the user. Coupon choices are then presented to the user for selection (step 603). The user then selects a coupon(s) (step 604). A coupon with the merchant's name, address, phone number, and conditions is downloaded to the user's phone (step 605). Optionally, the coupons can be downloaded to the user's phone immediately after step 602, and the user can select the desired coupons at a later time.

The user can then redeem the coupons with the participating merchants. The coupons which are transmitted to the user's mobile phone may take many forms including, for example, an electronic coupon, a text message or a graphical ad. The coupons could be set to automatically expire based on time (e.g. one day from deliver), or if the phone user leaves the “profile area” (e.g. the roaming user leaves the roaming area). Expired coupons would then be deleted from the phone's memory.

The phone can provide a menu from which the user selects the coupons which have been delivered. The coupons contain information about how to redeem the value. This might be done by means of a redemption code or a phone number. In addition, the coupons may contain information about the merchant, such as location, hours of business, and even an option to connect directly to the merchant. If the coupon does contain the option to connect directly, the connection might be specific, such as connecting directly to a particular department rather than the central operator. Another example would involve connecting directly with the reservation desk at a restaurant or hotel.

In addition to providing the user with information about the merchant, the merchant may also be sent information about the user including, for example, name and preferences. Such information would allow the merchant to provide better service. The merchant may also be notified every time a coupon has been sent to a user, so that the merchant is given a “heads up” and will be expecting the customer.

Referring to FIG. 7, a flowchart illustrating an example of how a customer may redeem an electronic coupon is depicted in accordance with the present invention. The customer proceeds to pay for the chosen product or service from the merchant and notifies the merchant of the coupon he wishes to redeem (step 701). The merchant may provide a communication link between a cash register and mobile phone so that the customer may provide evidence of the existence of a coupon (step 702). This may include an infrared data link between mobile phone and a cash register or some other type of data link. Another example would be to have an application in the phone or an applet in the coupon which could send the coupon to the merchant's register. In any case, the merchant may optionally require redemption information for the redeemed coupon, such as redemption ID stored in the electronic coupon (step 703). The redemption ID may allow a merchant to verify that the customer is entitled to coupon value applied against the purchase price of the product or service. The merchant then applies coupon value to the current purchase (step 704). The coupon database, stored within a phone company server, receives information concerning the redeemed coupon and updates a redeemed coupon database (step 705). The merchant may use the redemption ID to mark within the database that a coupon with the particular coupon ID has been already been used. In this manner a merchant may ensure that a customer does not attempt to reuse a coupon.

Alternatively, the merchant may allow an electronic coupon to be reused. In essence, the electronic coupon then becomes a standing coupon that may be used repeatedly by the customer. While browsing through the coupons on the mobile phone, the customer may see that the coupon may be reused in a variety of manners. The coupon may state in text that it is reusable, or the coupon properties may be set to show that it is reusable or renewable. In another manner, the expiration date of the coupon could be reset by the merchant as a purchase reward for purchasing a product within a specific time period.

While the present invention is applicable to anyone away from home, it is of particular value to travelers who may be very far from home and are unfamiliar with their surroundings. Travelers are unlikely to know much about their present location, let alone which merchants are offering coupons. The present invention will greatly assist travelers in locating goods and services that they normally would not have access to.

It should be emphasized that the present invention has applications beyond the use of mobile phones. For example, the database of merchant coupons could be accessed by means of a pager, laptop computer, personal digital assistant (PDA), or any other type of wireless communications device. In addition to a phone company, the coupon database could be provided by an internet service provider or other types of mobile communication providers.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for delivering coupons based on location, comprising:
creating an electronic database of merchant coupons;
receiving a request by means of a mobile communications device from a user seeking access the database;
determining the location of the user;
providing a menu of service preferences to the user;
receiving a service preference selection from the user; and
delivering coupons to the user based on the selected service preferences and location of the mobile device.

2. The method according to claim 1, wherein the database is maintained by a telephone service provider.

3. The method according to claim 1, wherein the database is maintained by an internet service provider.

4. The method according to claim 1, wherein the step of receiving a request for access to the database is by means of mobile telephone.

5. The method according to claim 1, wherein the step of determining the location of the mobile device is by means of the transmitting station through which the user request is received.

6. The method according to claim 1, wherein the step of determining the location of the mobile device is by means of triangulating the location of the wireless communications device.

7. The method according to claim 1, wherein the service preferences include retail, dining, automobile service, lodging and entertainment.

8. The method according to claim 1, wherein the service preferences are preselected and stored in the mobile communications device.

9. The method according to claim 1, wherein the service preferences are preselected and stored in a server within a wireless communications network.

10. The method according to claim 1, wherein the step of transmitting coupons based on preference selection and location further comprises selecting merchants within a defined radius of the user's location.

11. A method for receiving coupons in a mobile communications device, comprising:
sending a request from a user to access a database of merchant coupons;
remotely accessing the database server;
receiving a menu of service preferences for the user;
receiving a preference selection from the user;
transmitting the preference selection to the database server; and
receiving coupons based on the preference selection and location of the mobile device.

12. The method according to claim 11, wherein the database is maintained by a telephone service provider.

13. The method according to claim 11, wherein the database is maintained by an internet service provider.

14. The method according to claim 11, wherein the steps are performed by mobile telephone.

15. The method according to claim 11, wherein the service preferences include retail, dining, automobile service, lodging and entertainment.

16. The method according to claim 11, wherein the service preferences are preselected and stored in the wireless communications device.

17. The method according to claim 11, wherein the service preferences are preselected and stored in a server within a wireless communications network.

18. A method for obtaining coupons based on location, comprising:
submitting a request by means of a mobile communications device to access a database of merchant coupons;
receiving a menu of service preferences;
selecting service preferences; and
receiving coupons based on selected service preferences and present location.

19. The method according to claim 18, wherein the step of submitting the request for accessing the database is by means of mobile telephone.

20. The method according to claim 18, wherein the service preferences include retail, dining, automobile service, lodging and entertainment.

21. The method according to claim 18, further comprising preselecting the service preferences and storing them in the wireless communications device.

22. The method according to claim 18, further comprising preselecting the service preferences and storing them in a server within a wireless communications network.

23. A method for creating a database of merchant coupons, comprising:
creating and storing consumer profiles based on demographic characteristics;
providing a means for a merchant to scan through and select user profiles;
receiving and storing a merchant subscription to particular consumer profiles;
creating and storing electronic coupons for the merchant, wherein the electronic coupons contain conditions selected by the merchant and can be sent to a consumer by means of a wireless communications system;
assigning the electronic coupons to the consumer profiles subscribed to by the merchant; and
filtering the coupons to be sent to a consumer based on the location of the user as determined by a wireless communications system.

24. A computer program product in a computer readable medium for use in a data processing system, for delivering coupons based on location, the computer program product comprising:
instructions for creating an electronic database of coupons offered by merchants;
instructions for receiving a request by means of a mobile communications device from a user seeking access the database;
instructions for determining the locations of the user;
instructions for providing a menu of service preferences to the user;
instructions for receiving a service preference selection from the user; and
instructions for delivering coupons to the user based on the selected service preferences and location of the mobile device.

25. A computer program product in a computer readable medium for use in a data processing system, for receiving coupons in a mobile communications device, the computer program product comprising:
instructions for sending a request from a user to access a database of merchant coupons;
instructions for remotely accessing the database server;
instructions for receiving a menu of service preferences for the user;
instructions for receiving a preference selection from the user;
instructions for transmitting the preference selection to the database server; and
instructions for receiving coupons based on the preference selection and location of the device.

26. A computer program product in a computer readable medium for use in a data processing system, for creating a database of merchant coupons, comprising:
instructions for creating and storing consumer profiles based on demographic characteristics;
instructions for providing a means for a merchant to scan through and select user profiles;
instructions for receiving and storing a merchant subscription to particular consumer profiles;
instructions for creating and storing electronic coupons for the merchant, wherein the electronic coupons contain features selected by the merchant and can be sent to a consumer by means of a wireless communications system;
instructions for assigning the electronic coupons to the consumer profiles subscribed to by the merchant; and
instructions for filtering the coupons to be sent to a consumer based on the location of the user as determined by a wireless communications system.

27. A system for delivering coupons based on location, comprising:
means for creating an electronic database of coupons offered by merchants;
means for receiving a request by means of a mobile communications device from a user seeking access the database;
means for determining the location of the user;
means for providing a menu of service preferences to the user;
means for receiving a service preference selection from the user; and
means for delivering coupons to the user based on the selected service preferences and location of the device.

28. A system for receiving coupons in a mobile communications device, comprising:
means for sending a request from a user to access a database of merchant coupons;
means for remotely accessing the database server;
means for receiving a menu of service preferences for the user;
means for receiving a preference selection from the user;
means for transmitting the preference selection to the database server; and
means for receiving coupons based on the preference selection and location of the device.

29. A system for creating a database of merchant coupons, comprising:
means for creating and storing consumer profiles based on demographic characteristics;
means for a merchant to scan through and select user profiles;
means for receiving and storing a merchant subscription to particular consumer profiles;
means for creating and storing electronic coupons for the merchant, wherein the electronic coupons contain conditions selected by the merchant and can be sent to a consumer by means of a wireless communications system;
means for assigning the electronic coupons to the consumer profiles subscribed to by the merchant; and
means for filtering the coupons to be sent to a consumer based on the location of the user as determined by a wireless communications system.
